(19) United States
(12) Patent Application Publication
(10) Pub. No.: US 2026/0004808 A1
(43) Pub. Date: Jan. 1, 2026

(54) MAGNETIC RECORDING MEDIUM, METHOD OF FABRICATING MAGNETIC RECORDING MEDIUM, AND MAGNETIC STORAGE DEVICE

(71) Applicant: Resonac Hard Disk Corporation, Chiba (JP)

(72) Inventors: Yuki SATO, Chiba (JP); Masaru TAJIMA, Chiba (JP); Takayuki FUKUSHIMA, Chiba (JP)

(21) Appl. No.: 19/244,065

(22) Filed: Jun. 20, 2025

(30) Foreign Application Priority Data
Jun. 28, 2024 (JP) 2024-105136

(51) Int. Cl. G11B 5/66; G11B 5/851

(52) U.S. Cl. CPC G11B 5/66; G11B 5/851

(57) ABSTRACT

A magnetic recording medium includes a substrate, a base layer, a first magnetic layer, and a second magnetic layer, stacked in the order named. In this recording medium: the first magnetic layer contains magnetic particles having an L1₀ structure; the second magnetic layer has a granular structure, in which magnetic particles having the L1₀ structure, and grain boundaries including hexagonal boron nitride, are contained; (111) surfaces of the magnetic particles contained in the first magnetic layer are coated with aluminum nitride at an interface with the second magnetic layer; the magnetic particles contained in the second magnetic layer grow epitaxially from (001) surfaces of the magnetic particles contained in the first magnetic layer; and the magnetic particles contained in the first magnetic layer and the magnetic particles contained in the second magnetic layer form columnar crystals that penetrate, respectively, the first magnetic layer and the second magnetic layer.

### CROSS-REFERENCE TO RELATED APPLICATIONS

This application is based on and claims priority to Japanese Patent Application No. 2024-105136, filed on Jun. 28, 2024, the entire content of which is incorporated herein by reference.

### BACKGROUND OF THE INVENTION

### 1. Field of the Invention

The present disclosure relates to a magnetic recording medium, a method of fabricating the magnetic recording medium, and a magnetic storage device.

### 2. Description of the Related Art

In recent years, heat-assisted recording methods or microwave-assisted recording methods, in which evanescent light or microwaves are applied to a magnetic recording medium to heat the magnetic recording medium locally, reduce its coercivity, and record information on the magnetic recording medium, have been gaining popularity as next-generation recording methods whereby a high areal recording density of approximately 2 Tbit/inch² can be achieved.

By using a magnetic head supporting an energy-assisted recording method such as these, information can be recorded with ease on a magnetic recording medium having a coercivity of several tens of kOe at room temperature. The magnetic particles contained in the magnetic layers of the magnetic recording medium may be, for example, magnetic particles with a high magneto-crystalline anisotropy constant (Ku). Magnetic particles with a high magneto-crystalline anisotropy constant (Ku) can be made smaller while maintaining their thermal stability, resulting in increased coercivity at room temperature.

Examples of existing magnetic particles with a high magneto-crystalline anisotropy constant (Ku) include ones having an L1₀ structure, such as Fe—Pt alloy particles (Ku: maximum 7×10⁶ J/m³), Co-Pt alloy particles (Ku: maximum 5×10⁶ J/m³), etc.

As for examples of magnetic layers using magnetic particles having an L1₀ structure, non-patent document 1 discloses magnetic layers of a granular structure, in which L1₀-FePt magnetic particles are surrounded by a layered substance of hexagonal boron nitride.

### CITATION LIST

### Non-Patent Document

Non-Patent Document 1: B. S. D. Ch. S. Varaprasad et al., AIP Advances, 13, 035002 (2023)

### SUMMARY OF THE INVENTION

The present disclosure aims to provide:
(1) A magnetic recording medium including a substrate, a base layer, a first magnetic layer, and a second magnetic layer, stacked in the order named. In this magnetic recording medium: the first magnetic layer contains magnetic particles having an L1₀ structure; the second magnetic layer has a granular structure, in which magnetic particles having the L1₀ structure, and grain boundaries including hexagonal boron nitride, are contained; (111) surfaces of the magnetic particles contained in the first magnetic layer are coated with aluminum nitride at an interface with the second magnetic layer; the magnetic particles contained in the second magnetic layer grow epitaxially from (001) surfaces of the magnetic particles contained in the first magnetic layer; and the magnetic particles contained in the first magnetic layer and the magnetic particles contained in the second magnetic layer form columnar crystals that penetrate, respectively, the first magnetic layer and the second magnetic layer.
(2) The magnetic recording medium according to (1) above, in the magnetic particles having the L1₀ structure contained in the first magnetic layer and the magnetic particles having the L1₀ structure contained in the second magnetic layer are FePt alloy particles.
(3) A method of fabricating the magnetic recording medium of (1) or (2) above, the method including forming an aluminum nitride layer by sputtering, between forming of the first magnetic layer by sputtering and forming of the second magnetic layer by sputtering.
(4) A magnetic storage device including the magnetic recording medium of (1) or (2) above.

### BRIEF DESCRIPTION OF THE DRAWINGS

FIG. 1 is a cross-sectional view showing an example layer structure of a magnetic recording medium according to an embodiment of the present disclosure;

FIGS. 2A and 2B are cross-sectional schematic diagrams for explaining crystal growth that takes place when a first magnetic layer and a second magnetic layer are formed, where FIG. 2A is a cross-sectional schematic diagram showing existing crystal growth, and FIG. 2B is a cross-sectional schematic diagram showing crystal growth according to an embodiment of the present disclosure;

FIG. 3 is an oblique view showing an example magnetic storage device according to an embodiment of the present disclosure; and

FIG. 4 is a schematic diagram showing the magnetic head of FIG. 3.

### DETAILED DESCRIPTION OF THE DISCLOSURE

There is a demand to further improve the areal recording density of a magnetic recording medium. To improve the areal recording density of a magnetic recording medium, it is important to further reduce the size of the magnetic particles contained in the magnetic layers and further increase the anisotropy of the magnetic particles.

As one such magnetic layer, a magnetic layer of a granular structure, in which L1₀-FePt magnetic particles are oriented in the (001) direction and which contains hexagonal boron nitride in grain boundaries, has been proposed (hereinafter simply referred to as “FePt-hBN granular magnetic layer”).

Hexagonal boron nitride has a layered structure in which individual (001) surfaces are stacked in parallel; since it is easy to form grain boundaries between FePt magnetic particles, the size of the FePt magnetic particles can be made smaller. In addition, since the reactivity of hexagonal boron nitride to FePt magnetic particles is low, this does not prevent normalization of the magnetic particles. It is, furthermore, preferable if hexagonal boron nitride is formed such that: (001) surface surrounds the sides of the FePt magnetic particles.

However, in existing FePt-hBN granular magnetic layers, the magnetic particles and grain boundaries tend to be separate, and thus often fail to provide a granular structure. Also, the components in grain boundaries are often not sufficiently crystallized and remain in an amorphous state, as is the case with boron nitride (BN). Consequently, there is a problem that the areal recording density of the magnetic recording medium may not be improved even when magnetic layers formed in a granular structure (also referred to as “granular magnetic layers”) are used.

As stated earlier, the present disclosure aims to provide a magnetic recording medium that can stably maintain a state in which granular magnetic layers form a granular structure inside the magnetic recording medium, and that therefore can improve the areal recording density of the magnetic recording medium.

According to an example of the present disclosure, it is possible to provide a magnetic recording medium that can stably maintain a state in which granular magnetic layers form a granular structure inside the magnetic recording medium, and that therefore can improve the areal recording density of the magnetic recording medium.

According to another example of the present disclosure, it is possible to provide a method of fabricating a magnetic recording medium that can stably maintain a state in which granular magnetic layers form a granular structure inside the magnetic recording medium, and that therefore can improve the areal recording density of the magnetic recording medium.

According to yet another example of the present disclosure, it is possible to provide a magnetic storage device with a high recording capacity.

An embodiment of the present disclosure will be described below with reference to the accompanying drawings. Note that the drawings introduced in the following description may show characteristic parts/components of the present disclosure in an enlarged view so as to help understand the technical features of the present disclosure, and thus individual components may not be necessarily illustrated in the same size or proportions. In addition, in this specification, the preposition “to,” when used to indicate a numerical range, means that the numerical values preceding and following the preposition are included as the lower and upper limits of the numerical range, unless otherwise specified. When a numerical range indicated by the preposition “to” is written with a unit only on one limit (e.g., the upper limit), the unit applies to both limits (e.g., both the upper and lower limits).

### Magnetic Recording Medium

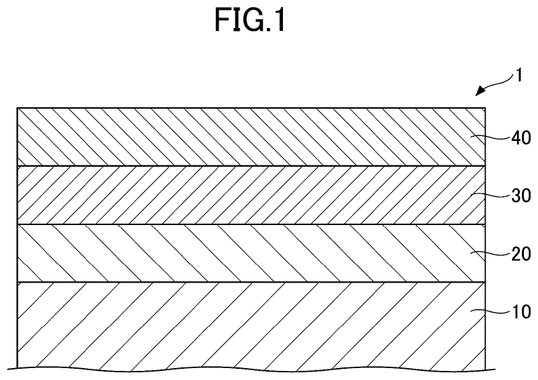

FIG. 1 shows an example layer structure of a magnetic recording medium according to an embodiment of the present disclosure. Referring to FIG. 1, a magnetic recording medium 1 has a substrate 10, a base layer 20, a first magnetic layer 30, and a second magnetic layer 40, stacked in this order.

The substrate 10 may be one that is commonly used for a magnetic recording medium such as the magnetic recording medium 1. For the substrate 10, it is preferable to use, for example, a heat-resistant glass substrate having a softening temperature of 500° C. or higher, more preferably 600° C. or higher. When fabricating the magnetic recording medium 1, a heat-resistant glass substrate can be used when the substrate 10 is heated to 500° C. or higher.

The material of the base layer 20 is not particularly limited as long as L1₀ magnetic particles contained in the first magnetic layer 30 and the second magnetic layer 40 can be oriented toward the (001) surface.

The base layer 20 may be multi-layered.

The base layer 20 preferably contains a NaCl compound.

Examples of the NaCl compound include MgO, TiO, NiO, TiN, TaN, HfN, NbN, ZrC, HfC, TaC, NbC, TiC, etc. One of these materials may be used alone, or two or more of these materials may be used together.

The first magnetic layer 30 contains L1₀ magnetic particles.

Examples of the L1₀ magnetic particles that constitute the first magnetic layer 30 include FePt alloy particles, CoPt alloy particles, etc. FePt alloy particles and CoPt alloy particles are both magnetic particles having an L1₀ structure and oriented in the (001) direction.

The magnetic particles contained in the first magnetic layer 30 are columnar crystals shaped to penetrate the first magnetic layer 30.

The size of the magnetic particles contained in the first magnetic layer 30 is not particularly limited as long as they are columnar, and their equivalent circular diameter may range from 3 nm to 7 nm, for example. The average size of the magnetic particles contained in the first magnetic layer 30 can be measured by looking at the particles through a planar transmission electron microscope.

The aspect ratio of the magnetic particles contained in the first magnetic layer 30 depends on the thickness of the first magnetic layer 30. For example, letting the columnar particles' height be “t” and their equivalent circular diameter be “D,” t/D may be 0.1 to 1.5. The aspect ratio of magnetic particles is, for example, the value obtained by dividing the particles' longest axis by the shortest axis. The aspect ratio of magnetic particles can also be obtained by dividing the magnetic particles' height, measured by looking at the particles through a cross-sectional transmission electron microscope, by the magnetic particles' average size, measured by looking at the particles through a planar transmission electron microscope.

The center-to-center distance between neighboring magnetic particles in the first magnetic layer 30 is preferably 4.0 nm to 8.0 nm. The center-to-center distance between neighboring magnetic particles in the first magnetic layer 30 is more preferably 7.8 nm or less, even more preferably 7.6 nm or less. If the center-to-center distance between neighboring magnetic particles in the first magnetic layer 30 is within the above preferred range, the first magnetic layer 30 can contain small-sized magnetic particles.

The center-to-center distance between magnetic particles refers to the distance between the respective centers of gravity of the magnetic particles. The center-to-center distance between neighboring magnetic particles can be measured, for example, by calculating the center-to-center distance between the respective centers of gravity of the magnetic particles based on a surface image observed through a scanning electron microscope (SEM).

The second magnetic layer 40 is a granular magnetic layer containing L1₀ magnetic particles and grain boundaries, and hexagonal boron nitride is contained in the grain boundaries.

Examples of the L1₀ magnetic particles that constitute the second magnetic layer 40 include FePt alloy particles, CoPt alloy particles, etc.

Like the magnetic particles contained in the first magnetic layer 30, the magnetic particles contained in the second magnetic layer 40 are columnar crystals shaped so as to penetrate the second magnetic layer 40.

Like the magnetic particles contained in the first magnetic layer 30, the size of the magnetic particles contained in the second magnetic layer 40 is not particularly limited as long as they are columnar, and their equivalent circle diameter of 3 nm to 7 nm, for example. The average particle size of the magnetic particles contained in the second magnetic layer 40 can be measured using the same method as that for the magnetic particles contained in the first magnetic layer 30.

Like the aspect ratio of the magnetic particles contained in the first magnetic layer 30, the aspect ratio of the magnetic particles contained in the second magnetic layer 40 depends on the thickness of the second magnetic layer 40 and, for example, t/D may be 1.2 to 2.5. Note that, letting the columnar particles' height be “t” and their equivalent circle diameter be “D,” the aspect ratio of the particles can be obtained by “t/D.” The aspect ratio of the magnetic particles contained in the second magnetic layer 40 can be measured using the same method as that used to measure the aspect ratio of the magnetic particles contained in the first magnetic layer 30.

The hexagonal boron nitride contained in grain boundaries is structured in layers such that individual (001) surfaces are stacked approximately in parallel; since it is easy to form grain boundaries between the magnetic particles contained in the second magnetic layer 40, the size of the magnetic particles contained in the second magnetic layer 40 can be made smaller. In addition, since the reactivity of hexagonal boron nitride to L1₀ magnetic particles is low, this does not prevent normalization of the magnetic particles contained in the second magnetic layer 40. Consequently, it is preferable if hexagonal boron nitride is formed such that its (001) surface surrounds the sides of the magnetic particles contained in the second magnetic layer 40.

With existing methods, it is difficult to form such granular magnetic layers in a stable manner. In other words, because the reactivity between magnetic alloys and boron nitride is low, the two are often formed into separate layers in the course of layer formation, and often a granular structure cannot be achieved. In addition, boron nitride often becomes amorphous without crystallizing.

The present inventors have found out that the granular structure of the second magnetic layer 40 can be formed in a stable manner by making the magnetic layers a two-layer structure formed with the first magnetic layer 30 and the second magnetic layer 40 stacked in order starting off from the substrate 10, and by epitaxially growing the magnetic particles of the second magnetic layer 40 from the magnetic particles of the first magnetic layer 30.

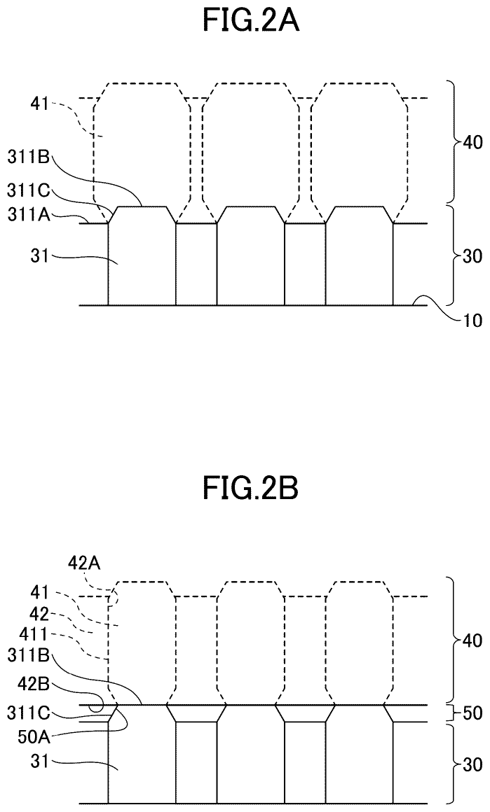

In this case, the magnetic particles on the of the first magnetic layer 30 growth surface constitute the (111) surface in addition to the (001) surface, when the second magnetic layer 40 is formed, crystal growth proceeds in a direction perpendicular to the (111) surface, and the magnetic particles of the second magnetic layer 40 coarsen. To prevent the magnetic particles in the second magnetic layer 40 from coarsening, according to the present embodiment, the (111) surface of the first magnetic layer 30 is coated with aluminum nitride, so that the magnetic particles of the second magnetic layer 40 can be prevented or substantially prevented from coarsening. This will be explained in detail with reference to FIG. 2.

FIGS. 2A and 2B show schematic cross-sectional view for explaining crystal growth that takes place when the first magnetic layer 30 and the second magnetic layer 40 are formed. To be more specific, FIG. 2A is a schematic cross-sectional view showing the crystal growth that takes place when an existing first magnetic layer 30 and an existing second magnetic layer 40 are formed. FIG. 2B is a schematic cross-sectional view showing the crystal growth that takes place when the first magnetic layer 30 and second magnetic layer 40 of the present embodiment are formed. Referring to FIG. 2A, on a growth surface 311A of magnetic particles 31 constituting the first magnetic layer 30 having an L1₀ structure and formed on the substrate 10, a (001) surface 311B and a (111) surface 311C are formed. The (001) surface 311B is parallel to the substrate 10. The (111) surface 311C is inclined downward at an angle of approximately 35 degrees toward the growth surface 311A (the lower side in FIG. 2) relative to the (001) surface 311B. When the second magnetic layer 40 (dashed-line part) is formed on the (111) surface 311C, the magnetic particles 41 of the second magnetic layer 40 also grow in the vertical direction of the (111) surface 311C of the magnetic particles 31, so that the magnetic particles 41 coarsen in size.

Conversely, referring to FIG. 2B, according to the present embodiment, the (111) surface 311C of the magnetic particles 31 of the first magnetic layer 30 is coated with an aluminum nitride layer 50. This prevents or substantially prevents the magnetic particles 41 of the second magnetic layer 40 (the dashed-line part) from coarsening, allows the magnetic particles 41 of the second magnetic layer 40 to grow epitaxially on the (001) surface 311B of the magnetic particles 31 of the first magnetic layer 30 and allows the magnetic particles 31 and 41 to be columnar crystals that penetrate the first magnetic layer 30 and the second magnetic layer 40, thus keeping the size of the magnetic particles 31 and 41 small.

According to the present embodiment, the aluminum nitride layer 50 contains aluminum nitride, preferably contains 50 atomic % (hereinafter “at %”) or more of aluminum nitride, and most preferably is composed only of aluminum nitride. Also, the aluminum nitride layer 50 is not a continuous layer but is a layer that partially penetrates between the magnetic particles 31 and the magnetic particles 41.

Referring to FIG. 2B, the hexagonal boron nitride grain boundary 42 contains hexagonal boron nitride, preferably contains 50 at % or more of hexagonal boron nitride, and most preferably is composed only of hexagonal boron nitride.

The content of hexagonal boron nitride grain boundaries 42 in the second magnetic layer 40 is preferably in the range of 25 volume % (hereinafter “vol %”) to 50 volt, and more preferably in the range of 35 vol % to 45 vol %. In the event the content of hexagonal boron nitride grain boundaries 42 in the second magnetic layer 40 is in the range of 25 vol % to 50 vol%, the coercivity HC of the magnetic recording medium 1, as well as the anisotropy of the magnetic particles 31 and 41 contained in the first magnetic layer 30 and the second magnetic layer 40, can be increased.

The method of measuring the content of hexagonal boron nitride grain boundaries 42 in the second magnetic layer 40 is not particularly limited, and so a general method of measuring the volume of particles can be used. For example, the content of hexagonal boron nitride grain boundaries 42 in the second magnetic layer 40 can be determined by elemental analysis of the hexagonal boron nitride grain boundaries 42 using electron energy-loss spectroscopy in transmission electron microscopy (TEM-EELS).

According to the present embodiment, like the second magnetic layer 40, the first magnetic layer 30 may employ a granular structure as well. In this case, the content of grain boundaries in the first magnetic layer 30 may be the same as that of the second magnetic layer 40.

### Method of Fabricating Magnetic Recording Medium

An example method of fabricating the magnetic recording medium 1 will be described below. The method of fabricating the magnetic recording medium 1 includes the steps of: forming a first magnetic layer 30 by sputtering; forming, over a main surface of the first magnetic layer 30, an aluminum nitride layer 50 by sputtering aluminum nitride; and forming, over a main surface of the aluminum nitride layer 50, a second magnetic layer 40 by sputtering. That is, according to the method of fabricating the magnetic recording medium 1, the step of forming the aluminum nitride layer 50 by sputtering comes between the step of forming the first magnetic layer 30 by sputtering and the step of forming the second magnetic layer 40 by sputtering. That is, the magnetic recording medium 1 is fabricated by providing the aluminum nitride layer 50 between the first magnetic layer 30 and the second magnetic layer 40. By using this method, the (111) surface 311C of the magnetic particles 31 on the growth surface of the first magnetic layer 30 can be coated with the aluminum nitride layer 50, so that the magnetic particles 41 of the second magnetic layer 40 can be prevented or substantially prevented from coarsening.

Examples of layer formation methods like this may include, for example, one in which: an RF discharge is employed by applying a discharge gas pressure of 2 Pa or less; a target surface potential of 50 to 200V is set; and layers, after they are formed, are heated (that is, post-annealed); and the heating temperature then is approximately 100° C. higher than the temperature at which the layers are formed. The gas atmosphere may be an inert gas atmosphere such as nitrogen or argon.

In a different example, after the aluminum nitride layer 50 is formed to cover the entire surface of the magnetic particles 31, the surface may be etched to remove only the aluminum nitride formed on the (001) surface 311B of the magnetic particles 31, so that it is possible to coat only the (111) surface 311C of the magnetic particles 31 with aluminum nitride, and form the aluminum nitride layer 50 only over the (111) surface 311C of the magnetic particles 31.

Etching aluminum nitride from the surface of the magnetic particles 31 brings about advantages of making nitrogen in the aluminum nitride more easily separable, and correcting nitrogen deficiencies in the hexagonal boron nitride grain boundaries 42 of the second magnetic layer 40 that is formed later. This makes it possible to shift the XPS peak of the hexagonal boron nitride grain boundaries 42 to near 191 eV, as is the case with a nitride. The hexagonal boron nitride grain boundaries 42 where nitridation is advanced show improved crystallinity, which makes it easier for the magnetic particles of hexagonal boron nitride to be more easily separable, and facilitates the columnar growth of hexagonal boron nitride.

Since the magnetic particles 31 and 41 contained in the first magnetic layer 30 and the second magnetic layer 40 form columnar crystals, it is preferable to enhance the c-axis orientation, that is, the orientation of the (001) surface, with respect to the substrate 10.

An example method of controlling the c-axis orientation of the magnetic particles 31 and 41 contained in the first magnetic layer 30 and the second magnetic layer 40 with respect to the substrate 10 is to allow, by using the base layer 20, the first magnetic layer 30 and the second magnetic layer 40 to grow epitaxially in the c-axis direction.

Another magnetic layer may be provided below the first magnetic layer 30 or above the second magnetic layer 40. This additional magnetic layer preferably contains L1₀ magnetic particles, as in the first magnetic layer 30. Furthermore, it is preferable that these additional magnetic particles form columnar crystals with the magnetic particles 31 and 41.

Thus, by using the above-described method of fabricating the magnetic recording medium 1, the magnetic recording medium 1 shown in FIG. 1 can be obtained.

It is preferable if the magnetic recording medium 1 has an additional protective layer on top of the first magnetic layer 30 and the second magnetic layer 40.

A hard carbon film is an example of this protective layer.

As for the method of forming the protective layer, radio frequency-chemical vapor deposition (RF-CVD), in which a film is formed by decomposing a hydrocarbon gas (source gas) with a high-frequency plasma, ion beam deposition (IBD), in which a film is formed by ionizing a source gas with electrons emitted from a filament, filtered cathodic vacuum arc (FCVA) deposition, in which a film is formed by using a solid carbon target, without using a source gas, etc. may be used.

The thickness of the protective layer is preferably 1 nm to 6 nm. In the event the protective layer is 1 nm thick or thicker, the levitation of the magnetic head improves; conversely, in the event the protective layer is 6 nm-thick or thinner, the magnetic spacing becomes narrower, and the signal-to-noise ratio (SNR) of the magnetic recording medium 1 improves.

The term “thickness of the protective layer” used herein refers to the dimension measured perpendicular to the main surface of the protective layer. For example, the thickness of the protective layer refers to its thickness measured at any location in the protective layer's cross section. If measurements are taken at several locations in the cross section of the protective layer, their average value may be used. This method of measuring thickness may be applied to other layers as well.

The magnetic recording medium 1 may additionally have a lubricant layer on top of the protective layer.

The lubricant layer can be formed using a liquid lubricant layer. For example, a liquid lubricant that is chemically stable, has low friction, and has low adsorption capacity is suitable for use. Examples of such lubricants include liquid fluororesin-based lubricants such as perfluoropolyether-based lubricants that contain a compound having a perfluoropolyether structure.

The thickness of the lubricant layer is not particularly limited, but may be, for example, 1 nm to 3 nm.

In addition to the protective layer and the lubricant layer, the magnetic recording medium 1 may include other layers if appropriate. For example, the magnetic recording medium 1 may have an adhesion layer, a soft-magnetic base layer, an orientation control layer, etc., between the substrate 10, the base layer 20, and the first magnetic layer 30, and so forth. The soft-magnetic base layer may be composed of, for example, a first soft magnetic layer, a middle layer, and a second soft magnetic layer. The orientation control layer may be a single layer or include two or more layers (for example, a first orientation control layer, a second orientation control layer, etc.). The materials of the adhesion layer, soft-magnetic base layer, orientation control layer, etc. may be general materials used for magnetic recording mediums.

As described above, the magnetic recording medium 1 has a substrate 10, a base layer 20, a first magnetic layer 30, and a second magnetic layer 40, stacked in this order. The first magnetic layer 30 includes magnetic particles 31 having an L1₀ structure. The second magnetic layer 40 is a granular magnetic layer containing magnetic particles 41 having an L1₀ boron structure and hexagonal nitride grain boundaries 42, and hexagonal boron nitride is contained in the hexagonal nitride grain boundaries 42. The (111) surface 311C of the magnetic particles 31 is coated with aluminum nitride at its interface with the second magnetic layer 40. The magnetic particles 41 grow epitaxially from the (001) surface 311B of the magnetic particles 31. Furthermore, the magnetic particles 31 and 41 are formed so as to be columnar crystals that penetrate the first magnetic layer 30 and the second magnetic layer 40. Consequently, the magnetic particles 31 and 41 are small and minute in size, and formed in a columnar shape that extends in one direction.

The magnetic recording medium 1 can reduce the size of the magnetic particles 31 and 41 contained in the first magnetic layer 30 and the second magnetic layer 40, respectively, and contain the magnetic particles 31 and 41 in a state in which they are linked with each other and continuous in the same direction, so that their anisotropy improves. As a result, the magnetic recording medium 1 can stably maintain the state in which a granular structure is formed inside the second magnetic layer 40, and contain the second magnetic layer 40 as a stable granular magnetic layer, so that the areal recording density of the magnetic recording medium 1 can be further improved.

With the characteristics and features described above, in the magnetic recording medium 1, Whether a heat-assisted recording method or a microwave-assisted recording method is used as the recording method, the first magnetic layer 30 and the second magnetic layer 40 achieve a high recording density, so that, the recording magnetic field from the magnetic head allows a sufficient volume of magnetic information to be recorded on the first magnetic layer 30 and the second magnetic layer 40. Thus, the magnetic recording medium 1 can be used suitably in a magnetic recording/playback device having an even higher recording density.

### Magnetic Storage Device

A magnetic storage device with the magnetic recording medium of the present embodiment will be described below. The magnetic storage device according to the present embodiment is not particularly limited in form as long as it includes the magnetic recording medium of the present embodiment. A case will be described below in which the magnetic storage device records magnetic information in the magnetic recording medium based on a heat-assisted recording method.

The magnetic storage device of the present embodiment may include, for example: a magnetic recording medium drive part that drives and rotates the magnetic recording medium of the present embodiment; a magnetic head having an evanescent light emitting element at its tip; a magnetic head drive part that drives and moves the magnetic head; and a recording/playback signal processing system.

The magnetic head supports a heat-assisted recording method, and has, for example, a laser light generating unit that generates laser light and heats the magnetic recording medium, and a wave guiding path that guides the laser light generated from the laser light generating unit to the evanescent light emitting element.

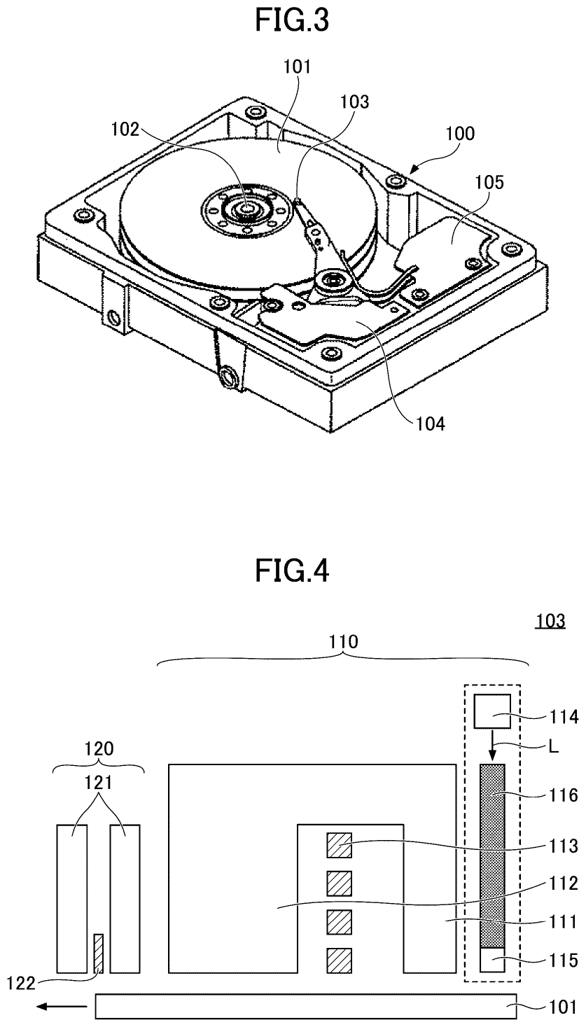

FIG. 3 shows a perspective view of an example magnetic storage device using the magnetic recording medium of the present embodiment. As shown in FIG. 3, the magnetic storage device 100 may have: a magnetic recording medium 101; a magnetic recording medium drive part 102 for allowing the magnetic recording medium 101 to rotate; a magnetic head 103 having an evanescent light emitting element at its tip; a magnetic head drive part 104 for allowing the magnetic head 103 to move; and a recording/reproducing signal processing unit 105. For the magnetic recording medium 101, the magnetic recording medium 1 described above is used.

FIG. 4 shows a schematic diagram of an example of the magnetic head 103. As shown in FIG. 4, the magnetic head 103 has a recording head 110 and a playback head 120.

The recording head 110 includes: a main magnetic pole 111; an auxiliary magnetic pole 112; a coil 113 that produces a magnetic field; a laser diode (LD) 114 that generates laser light L; and a wave guiding path 116 that guides the laser light L generated by the LD 114 to an evanescent light emitting element 115.

The playback head 120 includes: shields 121; and a playback element 122 that is sandwiched between the shields 121.

Referring to FIG. 3, in the magnetic storage device 100, the center of the magnetic recording medium 101 is attached to a spindle motor's rotating shaft. The magnetic head 103 moves in midair over the surface of the magnetic recording medium 101, which is driven and rotated by the spindle motor, and writes information to, or reads information from, the magnetic recording medium 101.

The magnetic storage device 100 according to the present embodiment uses the magnetic recording medium 1 for the magnetic recording medium 101, thus increasing the areal recording of density the magnetic recording medium 101 and increasing the recording capacity of the magnetic recording medium 101.

In addition, the magnetic storage device 100 may use a magnetic head for a microwave-assisted recording method for the magnetic head 103, instead of a magnetic head for a heat-assisted recording method.

Although an embodiment of the present disclosure has been described above, the above embodiment is only an example and by no means limits the scope of the present disclosure. The above embodiment can be carried out in a variety of different forms, and various combinations, omissions, substitutions, changes, etc. may be made without departing from the scope of the present disclosure. Such embodiments, as well as their modifications, shall be included in the scope and gist of the present disclosure, and are included in the scope of the invention and its equivalents as recited in the accompanying claims.

### Embodiment

The embodiment of the present disclosure will be explained in more detail below by showing examples and comparative examples. Nevertheless, the present disclosure is by no means limited to the technical details and features of the following examples and comparative examples.

### Fabrication of Magnetic Recording Medium

### EXAMPLE 1

On a glass substrate, a Cr-50 at % Ti alloy layer, which is 100-nm thick, and a Co-27 at % Fe-5 at % Zr-5at % B alloy layer, which is 30-nm thick, were formed in succession by sputtering as base layers. Next, the glass substrate was heated to 250° C., and then a 10-nm thick Cr layer and a 5-nm thick MgO layer were formed in succession by sputtering. Next, the glass substrate was heated to 450° C., and then a (Fe-48 at % Pt-5 at % B) alloy layer (first magnetic layer), which is 0.5-nm thick, was formed by sputtering.

Subsequently, a 0.2-nm thick aluminum nitride layer was formed by RF sputtering as a layer for coating the (111) surface. The conditions for forming the layer were: a target surface potential of 100V; a layer-forming rate of 0.08 nm/sec; and a post-annealing temperature that is approximately 100° C. higher than the layer-forming temperature.

Subsequently, etching was applied in an argon atmosphere of 0.5 Pa at 7 W.

As a result of this, the (111) surface of magnetic particles in the first magnetic layer was coated with an aluminum nitride layer.

Subsequently, a (Fe-49 at % Pt)-40 volume % hexagonal boron nitride layer (second magnetic layer), which is 13-nm thick, was formed in succession, using sputtering. Next, a 3-nm thick carbon film was formed as a protective layer. Thus, a magnetic recording medium was fabricated.

The composition and coating conditions of the first magnetic layer and the composition of the second magnetic layer are shown in Table 1 below.

### EXAMPLES 2 TO 7 AND COMPARATIVE EXAMPLES 1 TO 8

The same magnetic recording medium as that described above was fabricated and used in all of the examples/comparative examples listed in Table 1, except that the first magnetic layer's coating conditions were changed as shown in Table 1.

### Evaluation of Magnetic Recording Medium

The evaluation of each example and comparative example of the magnetic recording medium is as follows. In these evaluations, the state of aluminum nitride layer coating over the (111) surface of magnetic particles in first the magnetic layer and the crystallinity of hexagonal boron nitride (also referred to as “hBN”) were checked. In addition, the coercivity Hc of the magnetic recording medium and the center-to-center distance between magnetic particles in the first magnetic layer were measured.

### State of Coating of Magnetic Particles' (111) Surface with Aluminum Nitride Layer in First Magnetic Layer

The state of coating of the (111) surface of magnetic particles in the first magnetic layer with an aluminum nitride layer was evaluated by looking at the cross section of the magnetic recording medium through a transmission electron microscope (HD2300 by Hitachi High-Tech Corporation). If the thickness of the aluminum nitride layer is not uniform and the magnetic particles are linked with each other, the evaluation is: “DECREASE IN QUALITY OF COATING LAYER.”

### Crystallinity of Hexagonal Boron Nitride

The crystallinity of hexagonal boron nitride in the first magnetic layer was evaluated by looking at the cross section of the magnetic recording medium through a transmission electron microscope (HD2300 by Hitachi High-Tech Corporation) and observing the lattice fringes. When a crystalline material is seen through an electron microscope, lattice fringes can be seen at lattice spacing, so that the observer can confirm the crystallinity of hexagonal boron nitride in the first magnetic layer by looking at the cross section of the magnetic recording medium and looking lattice fringes through a transmission at the electron microscope. If the crystallinity of the hexagonal boron nitride is good, the state in which a granular structure is formed inside the second magnetic layer can be maintained stably. The evaluation in this case is that the second magnetic layer functions as a granular magnetic layer.

### Coercivity Hc of Magnetic Recording Medium

The coercivity Hc of the magnetic recording medium was evaluated by measuring the Kerr rotation angle when laser light (having a wavelength of 408nm) was incident on the main surface of the magnetic recording medium using a super-conducting Kerr measurement device (BH-810-HM7 by NEOARK Corporation). The coercivity Hc reflects the crystallinity of the magnetic particles in the first and second magnetic layers; instabilities in the crystal structure of the first and second magnetic layers are likely to lead to a decrease in the coercivity Hc. The evaluation in this case is that the higher the coercivity Hc, the higher the crystallinity of the first and second magnetic layers, and the more the areal recording density can be improved.

### Center-to-Center Distance between Magnetic Particles in First Magnetic Layer

The center-to-center distance between magnetic particles in the first magnetic layer was determined by looking at a surface image through an SEM and calculating the center-to-center distance between the respective centers of gravity of neighboring magnetic particles in the first magnetic layer. It is likely that the smaller the center-to-center distance between magnetic particles, the smaller the size of the magnetic particles is. The evaluation in this case is that the smaller the center-to-center distance between the magnetic particles in the first magnetic layer, the smaller the size of the magnetic particles in the first magnetic layer, and the more the areal recording density can be improved. When evaluating the size of the magnetic particles, argon etching was performed for 1 minute to remove the carbon protective film from the surface of the magnetic recording medium.

Table 1 shows: evaluation results of the state of coating of the (111) surface of magnetic particles with an aluminum nitride layer in the first magnetic layer and the crystallinity of hexagonal boron nitride; and results of measuring the coercivity Hc of the magnetic recording medium and the center-to-center distance between magnetic particles in the first magnetic layer.

TABLE 1

| | FIRST MAGNETIC LAYER | | | | | |
|---|---|---|---|---|---|---|
| | | COATING CONDITIONS | | | | |
| | | | GAS | | ETCHING | |
| | | COASTING | ATMOSPHERE | THICKNESS | POWER | SECOND MAGNETIC LAYER |
| | COMPOSITION | SUBSTANCE | (N₂) [Pa] | [nm] | [W] | COMPOSITION |
| EXAMPLE 1 | (Fe-48at % Pt) | AlN | 0 | 0.2 | 7 | (Fe-49at % Pt)-40 vol % hBN |
| EXAMPLE 2 | (Fe-48at % Pt) | AlN | 0 | 0.4 | 7 | (Fe-49at % Pt)-40 vol % hBN |
| EXAMPLE 3 | (Fe-48at % Pt) | AlN | 0 | 0.3 | 7 | (Fe-49at % Pt)-40 vol % hBN |
| EXAMPLE 4 | (Fe-48at % Pt) | AlN | 0 | 0.1 | 7 | (Fe-49at % Pt)-40 vol % hBN |
| EXAMPLE 5 | (Fe-48at % Pt) | AlN | 2.5 | 0.2 | 7 | (Fe-49at % Pt)-40 vol % hBN |
| EXAMPLE 6 | (Fe-48at % Pt) | AlN | 2.5 | 0.4 | 7 | (Fe-49at % Pt)-40 vol % hBN |
| EXAMPLE 7 | (Fe-48at % Pt) | AlN | 2.5 | 0.3 | 7 | (Fe-49at % Pt)-40 vol % hBN |
| EXAMPLE 8 | (Fe-48at % Pt) | AlN | 2.5 | 0.1 | 7 | (Fe-49at % Pt)-40 vol % hBN |
| COMPARATIVE | (Fe-48at % Pt) | NONE | NONE | 0 | 10 | (Fe-49at % Pt)-40 vol % hBN |
| EXAMPLE 1 | | | | | | |
| COMPARATIVE | (Fe-48at % Pt) | AlN | 0 | 0.8 | 10 | (Fe-49at % Pt)-40 vol % hBN |
| EXAMPLE 2 | | | | | | |
| COMPARATIVE | (Fe-48at % Pt) | AlN | 0 | 1.6 | 10 | (Fe-49at % Pt)-40 vol % hBN |
| EXAMPLE 3 | | | | | | |
| COMPARATIVE | (Fe-48at % Pt) | AlN | 0 | 0.2 | 0 | (Fe-49at % Pt)-40 vol % hBN |
| EXAMPLE 4 | | | | | | |
| COMPARATIVE | (Fe-48at % Pt) | AlN | 0 | 0.2 | 30 | (Fe-49at % Pt)-40 vol % hBN |
| EXAMPLE 5 | | | | | | |
| COMPARATIVE | (Fe-48at % Pt) | AlN | 0 | 0.2 | 70 | (Fe-49at % Pt)-40 vol % hBN |
| EXAMPLE 6 | | | | | | |
| COMPARATIVE | (Fe-48at % Pt) | SiO₂ | 0 | 0.2 | 0 | (Fe-49at % Pt)-40 vol % hBN |
| EXAMPLE 7 | | | | | | |

| | MAGNETIC RECORDING MEDIUM'S CHARACTERISTICS | | | |
|---|---|---|---|---|
| | STATE IN WHICH MAGNETIC | | | CENTER-TO-CENTER |
| | PARTICLES' (111) SURFACE | | | DISTANCE BETWEEN |
| | IS COATED WITH | | | MAGNETIC PARTICLES |
| | ALUMINUM LAYER IN | hBN | Hc | IN FIRST MAGNETIC |
| | FIRST MAGNETIC LAYER | PEAK | [kOe] | LAYER [nm] |
| EXAMPLE 1 | GOOD | GOOD | 35.0 | 8.6 |
| EXAMPLE 2 | GOOD | GOOD | 37.6 | 8.2 |
| EXAMPLE 3 | GOOD | GOOD | 36.2 | 8.4 |
| EXAMPLE 4 | GOOD | GOOD | 32.1 | 8.8 |
| EXAMPLE 5 | GOOD | GOOD | 35.6 | 8.6 |
| EXAMPLE 6 | GOOD | GOOD | 38.5 | 8.1 |
| EXAMPLE 7 | GOOD | GOOD | 36.8 | 8.5 |
| EXAMPLE 8 | GOOD | GOOD | 33.3 | 8.8 |
| COMPARATIVE | NO COATING | GOOD | 30.9 | 9.1 |
| EXAMPLE 1 | | | | |
| COMPARATIVE | (001) SURFACE IS | GOOD | 35.6 | 9.2 |
| EXAMPLE 2 | ALSO COATED | | | |
| COMPARATIVE | (001) SURFACE IS | GOOD | 12.3 | 8.1 |
| EXAMPLE 3 | ALSO COATED | | | |
| COMPARATIVE | (001) SURFACE IS | POOR | 31.0 | 9.2 |
| EXAMPLE 4 | ALSO COATED | | | |
| COMPARATIVE | NO COATING | POOR | 25.5 | 8.7 |
| EXAMPLE 5 | | | | |
| COMPARATIVE | NO COATING | POOR | 17.9 | 8.8 |
| EXAMPLE 6 | | | | |
| COMPARATIVE | DECREASE IN QUALITY | POOR | 6.8 | 7.6 |
| EXAMPLE 7 | OF COATING LAYER | | | |

Table 1 shows that the magnetic recording medium of each embodiment had high coercivity Hc. It is confirmed that: by coating the (111) surface of magnetic particles in the first magnetic layer with aluminum nitride, the size of the magnetic particles contained in the first magnetic layer and the second magnetic layer can be reduced; and that the second magnetic layer can function as a granular magnetic layer and maintain the state in which a granular structure is formed inside it. As described above, the magnetic recording medium of the present disclosure achieves a high areal recording density, thus also achieving a high recording capacity when used in a magnetic storage device.

What is claimed is:

1. A magnetic recording medium comprising a substrate, a base layer, a first magnetic layer, and a second magnetic layer, stacked in order named,
wherein the first magnetic layer contains magnetic particles having an L1₀ structure,
wherein the second magnetic layer has a granular structure, in which magnetic particles having the L1₀ structure, and grain boundaries including hexagonal boron nitride, are contained,
wherein (111) surfaces of the magnetic particles contained in the first magnetic layer are coated with aluminum nitride at an interface with the second magnetic layer,
wherein the magnetic particles contained in the second magnetic layer grow epitaxially from (001) surfaces of the magnetic particles contained in the first magnetic layer, and
wherein the magnetic particles contained in the first magnetic layer and the magnetic particles contained in the second magnetic layer form columnar crystals that penetrate, respectively, the first magnetic layer and the second magnetic layer.

2. The magnetic recording medium according to claim 1, wherein the magnetic particles having the L1₀ structure contained in the first magnetic layer and the magnetic particles having the L1₀ structure contained in the second magnetic layer are FePt alloy particles.

3. A method of fabricating the magnetic recording medium of claim 1, the method comprising forming aluminum nitride layer by sputtering, between forming of the first magnetic layer by sputtering and forming of the second magnetic layer by sputtering. 10 4. A magnetic storage device comprising the magnetic recording medium of claim 1.
